(19) United States
(12) Patent Application Publication
(10) Pub. No.: US 2004/0240332 A1
(43) Pub. Date: Dec. 2, 2004

(54) Tray having blocking portion for an optical disc driver

(76) Inventor: Ching-Chang Meng, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/858,937

(22) Filed: Jun. 1, 2004

(30) Foreign Application Priority Data
May 30, 2003 (CN) 03246882.2

(51) Int. Cl. G11B 7/085

(52) U.S. Cl. 369/30.99

(57) ABSTRACT

A tray (1) having blocking portion for an optical disc driver can be received in a housing (2). The tray includes a main body (11) and a blocking portion (12). The main body includes a rear end (114) received in the optical disc driver and a front end (113). The front end can move out of the optical disc driver. A recess (115) is defined in the main body, for accommodating an optical disc therein. The blocking portion has a protrusion (123), a free end (121), and a connecting end (122). The tray is prevented from sliding completely out of the optical disc driver by the blocking portion. When the tray is manually pulled, the blocking portion is bent inwardly, and the tray is completely detachable from the optical disc driver. The blocking portion helps prevent the tray from being damaged or broken.

### BACKGROUND OF THE INVENTION

1. Field of the Invention

The present invention relates to an optical disc driver, and more particularly to an optical disc driver having a tray that is prevented from sliding completely out from a housing.

2. Description of Prior Art

An optical disc driver is an optical recording/reproduction apparatus which is widely used in computers. A tray carrying an optical disc moves in or out of the optical disc driver, for loading and unloading of the optical disc. When the tray carries the optical disc out of the optical disc driver, a blocking component arranged on the tray prevents the tray from sliding completely out from the optical disc driver.

A typical example of such an arrangement is disclosed in U.S. Pat. No. 5,864,529, and is represented in FIG. 6 hereof. A pair of spurs 90 is arranged at an end of a tray 9. Each spur 90 comprises a first end 91 and a second end 92. The first end 91 is parallel with a main surface 94 of the tray 9, and the second end 92 extends vertically upwardly from the spur 90 at a point corresponding to the main surface 94 of the tray 9. Each spur 90 cooperates with a corresponding stopper (not shown) of a housing (not shown), for preventing the tray 9 from sliding completely out from the housing. When each spur 90 is pulled against the stopper, the second end 92 is pressed by a force F in order to stop the tray 9 from sliding completely out of the housing. However, if the force F is excessive, the spurs 90 may bend along direction A until the spurs 90 is damaged or broken. Moreover, when the optical disc driver needs repairing, it is inconvenient to draw the tray 9 completely out of the driving housing.

### SUMMARY OF THE INVENTION

Accordingly, an object of the present invention is to provide a tray which can be conveniently drawn completely out of an optical disc driver when needed.

Another object of the present invention is to provide a tray which can be attached to a housing of an optical disc driver in a way that prevents the tray from sliding completely out from the housing.

In order to achieve the objects set out above, a tray having blocking portion for an optical disc driver of the present invention which can be received in a housing includes a main body and a blocking portion. The main body includes a rear end received in the optical disc driver and a front end. The front end can move out of the optical disc driver. A recess is defined on the main body for accommodating an optical disc therein. The blocking portion has a protrusion, a free end and a connecting end. The tray is prevented from sliding completely out of the optical disc driver by the blocking portion. When the tray is manually pulled, the blocking portion is bent inwardly, and the tray is completely detachable from the optical disc driver. The blocking portion helps prevent the tray from being damaged or broken.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of a tray in accordance with the present invention, and a housing for receiving the tray;

FIG. 2 is an isometric view of the tray of FIG. 1, but viewed from another aspect;

FIG. 3 is an enlarged view of a circled portion III of FIG. 2;

FIG. 4 is a top elevation of the tray accommodated inside the housing of FIG. 1;

FIG. 5 is similar to FIG. 4, but showing the tray slid outside of the housing; and

FIG. 6 is an isometric view of a conventional tray for an optical disc driver.

### DETAILED DESCRIPTION OF THE INVENTION

Reference will now be made to the drawing figures to describe the preferred embodiment of the present invention in detail.

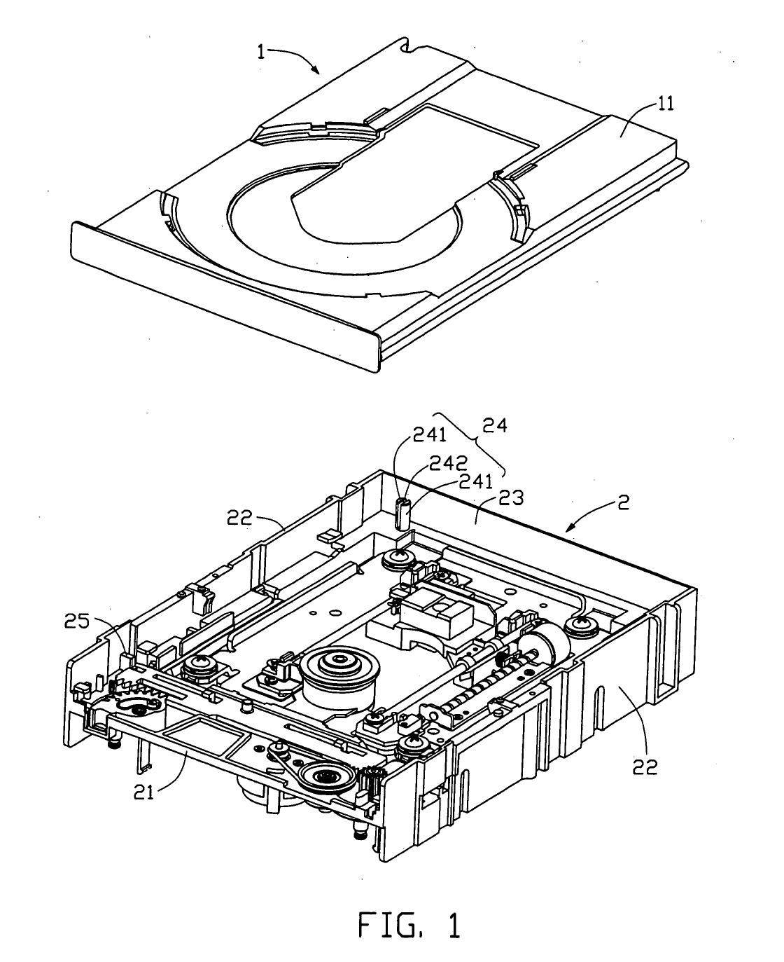

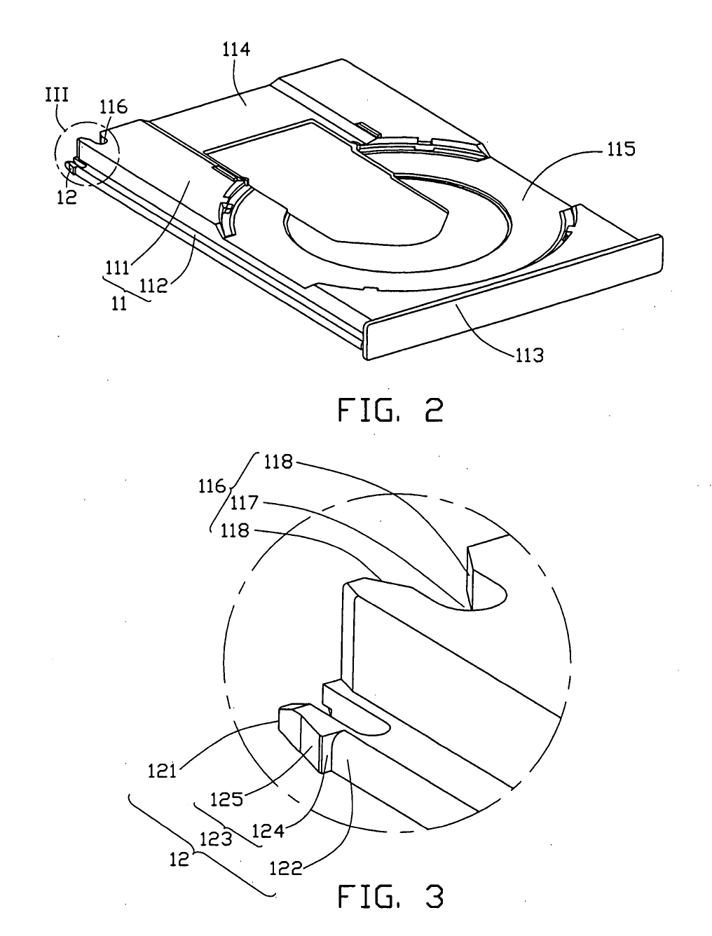

As shown in FIGS. 1-3, a tray 1 for an optical disc driver in accordance with a preferred embodiment of the present invention can be received in a housing 2. The tray 1 includes a main body 11, and a blocking portion 12 integrally formed with the main body 11. The tray 1 carries an optical disc (not shown) into or out of the housing 2, for loading and unloading of the optical disc.

The main body 11 comprises a first plate 111, a pair of second plates 112 extending outwardly and horizontally from each of opposite lateral side edges of the first plate 111, a rear end 114 which can slide inside the housing 2, and a front end 113 which can slide out of the housing 2. A recess 115 is defined in the first plate 111, for accommodating the optical disc therein. A receptacle 116 is defined in the rear end 114 of the first plate 111. The receptacle 116 comprises a mounting slot 117, and a pair of tapered guiding surfaces 118 leading to the mounting slot 117.

The blocking portion 12 is longitudinally formed at a rear end of one of the second plates 112. The blocking portion 12 comprises a generally U-shaped blocking slot (not labeled), a free end 121, a connecting end 122, and a protrusion 123 projecting outwardly between the free end 121 and the connecting end 122. The protrusion 123 comprises a blocking surface 124, and a slanted surface 125 adjoining the blocking surface 124. The blocking surface 124 perpendicularly adjoins the connecting end 122, and the slanted surface 125 slantingly interconnects the blocking surface 124 and the free end 121.

The housing 2 has a bottom wall 21, a back wall 23, and two side walls 22 extending from opposite side edges of the bottom wall 21 respectively. A cylindrical locating post 24 is formed on a corner of the bottom wall 21 near the back wall 23. A through slot 242 is defined vertically in a middle of the locating post 24, thus dividing the locating post 24 into two symmetrically opposite generally semicylindrical deflectable portions 241. The through slot 242 is parallel to the side walls 22. A diameter of the locating post 24 is greater than a width of the mounting slot 117. The locating post 24 elastically engages in the receptacle 116 to locate the tray 1 in the housing 2. A stopper 25 is formed on the side wall 22 The stopper 25 can cooperate with the blocking portion 12 of the tray 1 in order to prevent the tray 1 from sliding completely out of the housing 2.

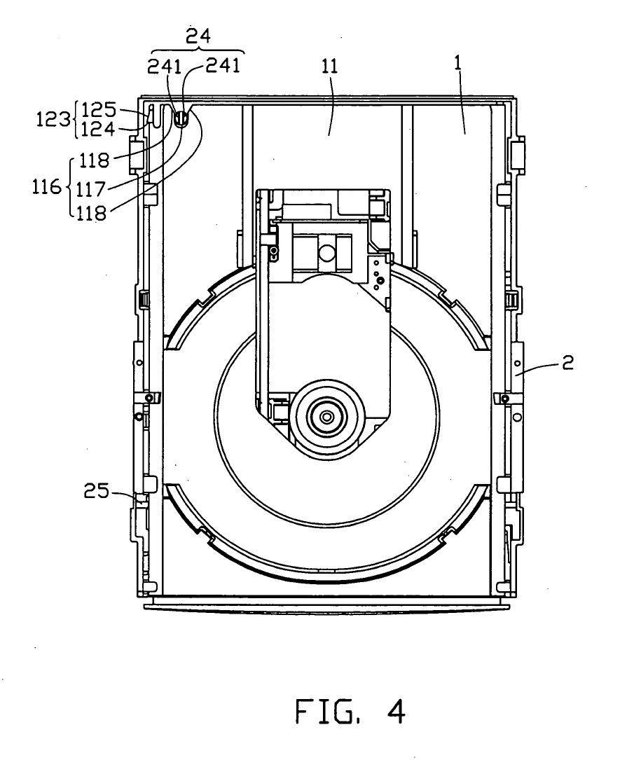

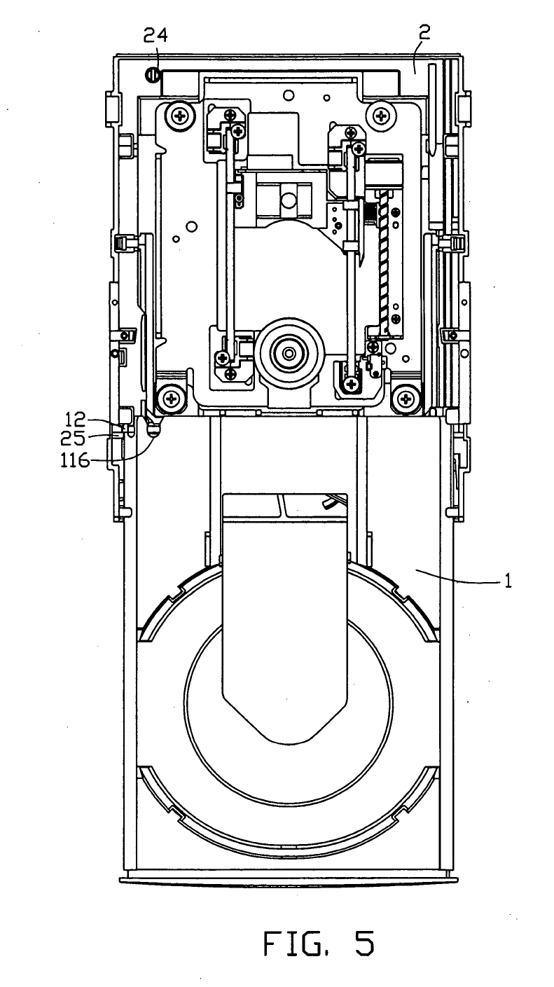

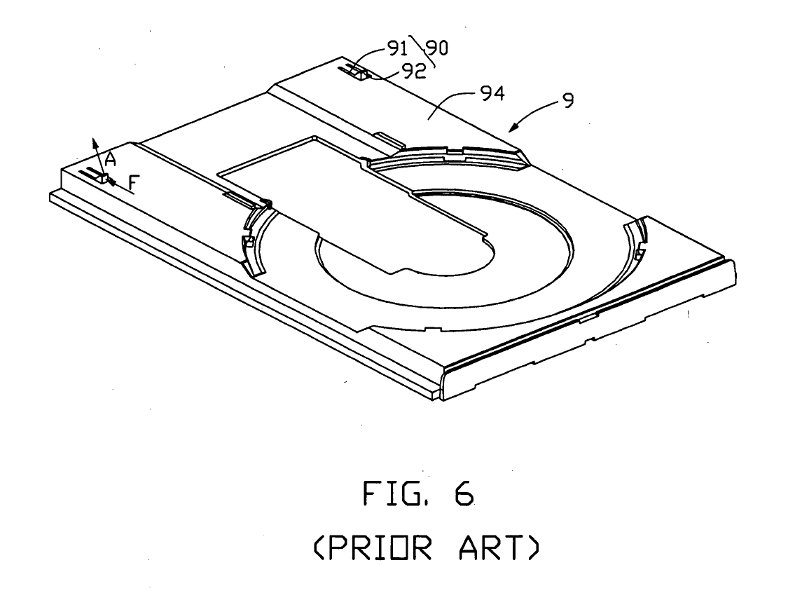

As shown in FIGS. 4-5, the tray 1 is mounted in the housing 2. When the tray 1 is slid into the housing 2, the locating post 24 firstly contacts the guiding surfaces 118 of the receptacle 116, and is guided by the guiding surfaces 118 to the mounting slot 117 of the receptacle 116. The locating post 24 then elastically deforms and slidingly engages in the mounting slot 117. In this position, the tray 1 is completely received in the housing 2. Because the diameter of the locating post 24 is greater than the width of the mounting slot 117, the deflectable portions 241 of the locating post 24 are elastically bent toward each other. There are no gaps between the deflectable portions 241 and a wall of the mounting slot 117. This helps reduce vibration of the tray 1 during recording/reproduction of data on the optical disc.

When the tray 1 slides out of the housing 2, the blocking portion 12 of the tray 1 engages with the stopper 25 of the housing 2, thereby preventing the tray 1 from sliding completely out of the housing 2. When the tray 1 needs to be completely detached from the housing 2, the tray is manually pulled so that the stopper 25 of the housing 2 applies force on the blocking surface 124. This causes the free end 121 of the blocking portion 12 to bend inwardly, and the blocking surface 124 is then released from engagement with the stopper 25. The tray 1 can then be easily drawn completely out of the housing 2.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tray for being received in a housing of an optical disc driver, comprising:
a main body comprising a recess for receiving an optical disc, a back end sliding inside the housing, and a front end sliding out of the housing; and
a blocking portion formed on the main body, the blocking portion comprising a free end, a connecting end connecting with the main body, and a protrusion projecting outwardly between the connecting end and the free end.

2. The tray as recited in claim 1, wherein the main body comprises a first plate, and a second plate extending outwardly from a side edge of the first plate.

3. The tray as recited in claim 2, wherein the recess is defined in the first plate.

4. The tray as recited in claim 2, wherein the blocking portion is formed at a rear end of the second plate.

5. The tray as recited in claim 1, wherein the blocking portion further comprises a U-shaped blocking slot, and the free end of the blocking portion can be elastically bent towards the blocking slot.

6. The tray as recited in claim 1, wherein the protrusion extends outwardly at a side edge of the connecting end.

7. The tray as recited in claim 6, wherein the protrusion comprises a blocking surface and a slanted surface adjoining the blocking surface.

8. The tray as recited in claim 7, wherein the blocking surface perpendicularly adjoins the connecting end.

9. The tray as recited in claim 8, wherein the slanted surface interconnects the blocking surface and the free end.

10. The tray as recited in claim 1, wherein the housing futher comprises a stopper which can cooperate with the protrusion of the blocking portion in order to prevent the tray from sliding completely out of the housing.

11. A tray assembly comprising:
a housing receiving a plurality of components therein; and
a tray including:
a main body comprising a recess for receiving an optical disc, a back end sliding inside the housing, and a front end sliding out of the housing; and
a blocking portion formed on the main body and defining a deflectable protrusion; wherein
the main body defines a slot to receive a shrinkable locating post extending from the housing, when the block portion reaches a fixed position, so as to assure the tray is immoveable relative to the housing.

12. The tray assembly as claimed in claim 11, wherein the tray is slidably moved relative to the housing in a front-to-back direction, and said slot communicates with an exterior along said front-to-back direction.
